(19) United States
(12) Patent Application Publication
(10) Pub. No.: US 2025/0234120 A1
(43) Pub. Date: Jul. 17, 2025

(54) VEHICLE ELECTROACOUSTIC TRANSDUCER

(71) Applicant: FOSTER ELECTRIC COMPANY, LIMITED, Tokyo (JP)

(72) Inventors: Gaku Kubota, Akishima-shi, Tokyo (JP); Atsushi Koga, Akishima-shi, Tokyo (JP); Takayuki Tabata, Akishima-shi, Tokyo (JP)

(21) Appl. No.: 18/851,667

(22) PCT Filed: Mar. 6, 2023
(86) PCT No.: PCT/JP2023/008416

§ 371 Date: Mar. 24, 2025

(30) Foreign Application Priority Data
Mar. 29, 2022 (JP) 2022-053453

(51) Int. Cl. H04R 1/02; B60R 11/02

(52) U.S. Cl. CPC H04R 1/026; B60R 11/0217; H04R 1/025; H04R 2499/13

(57) ABSTRACT

An electroacoustic transducer for a vehicle includes: a speaker unit that generates sound; and a case that is formed in a box-shape and accommodates the speaker unit, and that includes a peripheral wall portion that surrounds a periphery of the speaker unit, a front wall portion disposed at one end side of the peripheral wall portion, and a rear wall portion disposed at another end side of the peripheral wall portion, with an attachment portion that protrudes from the rear wall portion toward an opposite side from a side of the front wall portion, and that is attachable to an attachment member outside a vehicle cabin, being formed at the case.

### TECHNICAL FIELD

The present invention relates to an electroacoustic transducer for a vehicle.

### RELATED ART

In Japanese Patent Application Laid-open (JP-A) Nos. 2021-29003 and 2021-29004, a vehicle electroacoustic transducer is disclosed in which a speaker unit is fixed inside a main body case. In the vehicle electroacoustic transducers described in these Patent Documents 1 and 2, an internal space and an external space of a main body case are partitioned with a vibrating body as a boundary, and by providing ventilating members in communicating holes that communicate the spaces with each other, passage of air is permitted and passage of fluid is blocked.

### SUMMARY OF THE INVENTION

### Problem to be Solved by the Invention

Incidentally, in order to attach the vehicle electroacoustic transducer to an attachment member, it is necessary to provide an attachment portion at the case or the like. Here, in the vehicle electroacoustic transducers described in JP-A Nos. 2021-29003 and 2021-29004, a pair of flanges extend from the main body case toward the outside in opposite directions from each other, and the vehicle electroacoustic transducer is attached to the attachment member via these flanges. This requires a large amount of space for attachment of the vehicle electroacoustic transducer. In particular, in cases in which an electroacoustic transducer for a vehicle is installed outside the vehicle cabin in order to generate sound to the outside of the vehicle, because it is necessary to design the outside of the vehicle interior in a compact manner in order to secure space inside the vehicle interior, there is demand for electroacoustic transducers for a vehicle that are capable of being installed in a small space.

An object of the present invention is to provide an electroacoustic transducer for a vehicle that can be installed in a small space.

### Means for Solving the Problem

A vehicle electroacoustic transducer according to a first aspect includes: a speaker unit that generates sound; and a case that is formed in a box-shape and accommodates the speaker unit, and that includes a peripheral wall portion that surrounds a periphery of the speaker unit, a front wall portion disposed at one end side of the peripheral wall portion, and a rear wall portion disposed at another end side of the peripheral wall portion, in which an attachment portion that protrudes from the rear wall portion toward an opposite side from a side of the front wall portion, and that is attachable to an attachment member outside a vehicle cabin, is formed at the case.

In the above aspect, the speaker unit is housed in the case, and the case is configured including a peripheral wall portion, a front wall portion, and a rear wall portion. Further, since an attachment portion is formed at the case, the case can be attached to an attachment member outside the vehicle cabin via the attachment portion.

Note that the attachment portion protrudes from the rear wall portion of the case toward an opposite side from the front wall portion side. This enables the case to be attached in a smaller space than in a configuration in which the attachment portion is provided around the peripheral wall portion.

A vehicle electroacoustic transducer according to a second aspect is the first aspect, in which the attachment portion includes an attachment bracket that is separate from the case, and a bracket housing portion formed integrally with the case and provided with an insertion hole into which the attachment bracket is insertable.

In the above aspect, since the attachment bracket has an “outsert” structure in which the attachment bracket is inserted into the insertion hole of the bracket housing portion, compared to the structure of an insert in which an attachment bracket is integrally molded at a case, water is less likely to remain at the interface between the case and the attachment bracket. This enables deterioration of the interface between the case and the attachment bracket under the influence of water or the like to be suppressed.

A vehicle electroacoustic transducer according to a third aspect is the second aspect, in which a through-hole penetrable by a fastener is formed at the bracket housing portion, and a screw hole is formed at the attachment bracket, the screw hole being communicated with the through-hole in a state in which the attachment bracket is housed in the bracket housing portion, and into which the fastener is screwed.

In the above aspect, when the case is attached to the attachment member by the fastener, the fastener and the attachment bracket are screwed together in a state in which the fastener is inserted into the insertion hole formed in the bracket housing portion. Thus, the bracket housing portion assumes a state sandwiched between the attachment bracket and the fastener, thereby enabling the case to be more firmly attached to the attachment member.

A vehicle electroacoustic transducer according to a fourth aspect is the third aspect, in which the attachment bracket includes a cylindrical portion at which the screw hole is formed, and a flange portion extending from the cylindrical portion in a radial direction of the cylindrical portion, and the flange portion is formed in a laterally elongate shape such that a length in one direction is longer than a length in another direction among two directions orthogonal to a plate thickness direction.

In the above aspect, by configuring the flange portion of the attachment bracket in a laterally elongate shape, even in cases in which an impact has been input to the attachment portion from the attachment member side, the impact can be dispersed by the flange portion. In cases in which the flange portion is formed in a circular shape with a large diameter, the bracket housing portion itself needs to be made larger in size; however, by configuring the flange portion in a laterally elongate shape, the length in the other direction is shortened, and therefore, there is no need to make the bracket housing portion larger in size.

A vehicle electroacoustic transducer according to a fifth aspect is any one of the second to the fourth aspects, in which the attachment portion is formed such that a gap is provided between the bracket housing portion and the attachment bracket, and the attachment bracket is detachable in a state in which the attachment bracket is housed in the bracket housing portion.

In the above aspect, since a gap is provided between the bracket housing portion and the attachment bracket, the attachment bracket can be easily attached and detached. This enables the operational efficiency of the operation of inserting the attachment bracket into the bracket housing portion to be improved. Further, the attachment bracket can be easily changed in accordance with the specifications or the like of the attachment member.

### Effect of Invention

The vehicle electroacoustic transducer according to the present disclosure can be installed in a small space.

### BRIEF DESCRIPTION OF THE DRAWINGS

FIG. 1 is an exploded perspective view of an electroacoustic transducer for a vehicle according to an exemplary embodiment.

FIG. 2 is a cross-section viewed from the left side of an electroacoustic transducer for a vehicle according to an exemplary embodiment.

FIG. 3 is a perspective view of an electroacoustic transducer for a vehicle according to an exemplary embodiment, illustrating a state prior to insertion of an attachment bracket.

FIG. 4 is a top view of an electroacoustic transducer for a vehicle according to an exemplary embodiment.

FIG. 5 is a cross-section along line 5-5 in FIG. 4.

### DESCRIPTION OF THE INVENTION

Explanation follows regarding a vehicle electroacoustic transducer 10 according to an exemplary embodiment, with reference to the drawings. Note that in each of the drawings, as appropriate, the arrow FR, the arrow UP, and the arrow RH respectively indicate the front direction, upper direction, and right direction of the vehicle electroacoustic transducer 10. However, the front-rear direction, the up-down direction, and the left-right direction of the vehicle electroacoustic transducer 10 are set for convenience of explanation, and do not necessarily coincide with the front-rear direction, the up-down direction, and the left-right direction in a state in which the vehicle electroacoustic transducer 10 is attached to an attachment member.

### (Overall Configuration of Vehicle Electroacoustic Transducer 10)

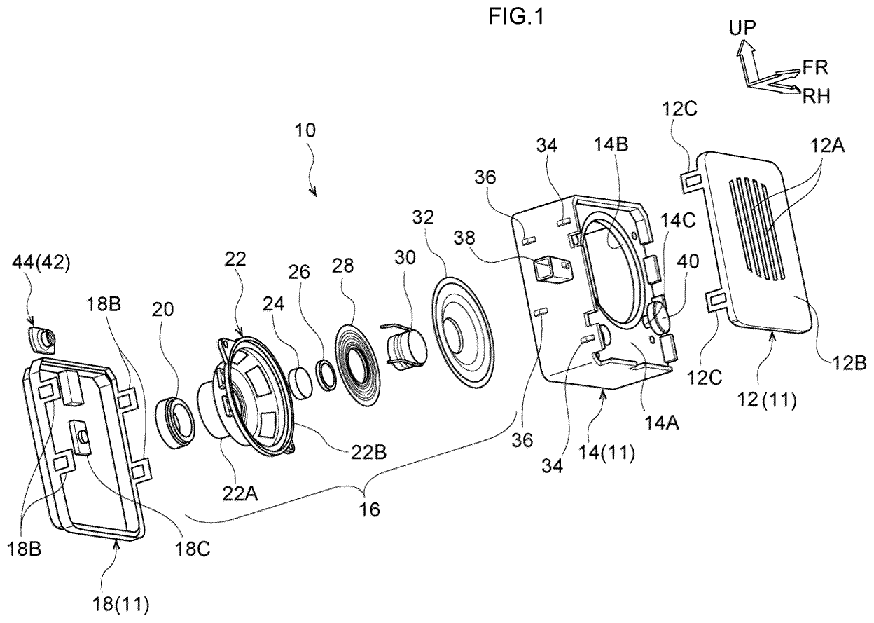

As illustrated in FIG. 1, the vehicle electroacoustic transducer 10 of the present exemplary embodiment is mainly configured including a front cover 12, a case body 14, a speaker unit 16, and a rear cover 18. A case 11 is configured by the front cover 12, the case body 14, and the rear cover 18, and the speaker unit 16 is housed in the case 11.

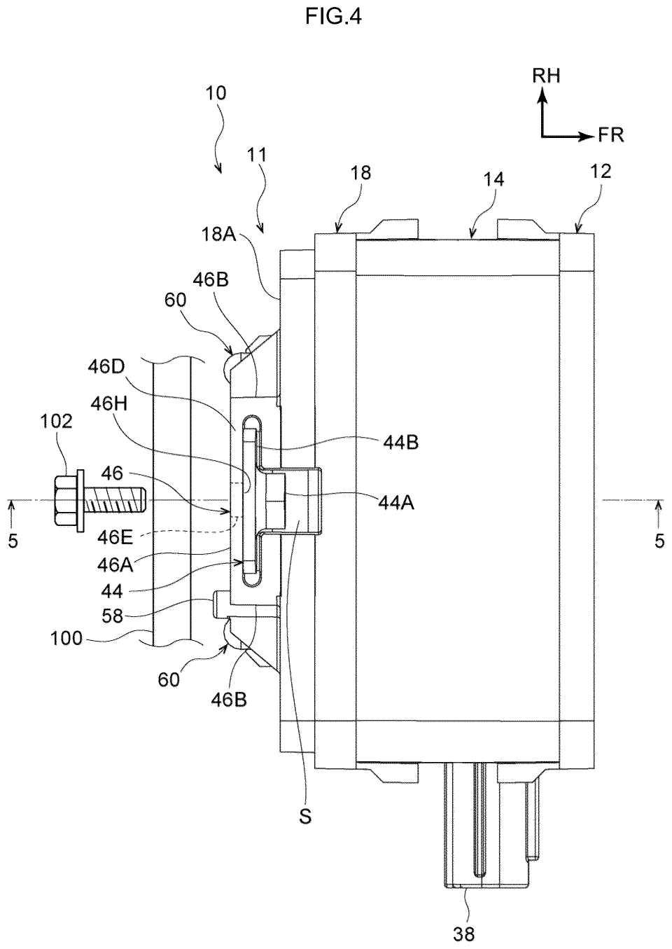

Note that the vehicle electroacoustic transducer 10 of the present exemplary embodiment is installed in a power unit room provided outside a vehicle cabin, for example, and is configured so as to be attached to an attachment member 100 (see FIG. 4) installed in the power unit chamber. As an example, the vehicle electroacoustic transducer 10 of the present exemplary embodiment is used as an acoustic vehicle alerting system (AVAS) that notifies a pedestrian of vehicle approach by generating sound during low-speed driving in a state in which it is installed in a vehicle.

First, explanation follows regarding the speaker unit 16 configuring the vehicle electroacoustic transducer 10 of the present exemplary embodiment, and details of the front cover 12, the case body 14, and the rear cover 18 configuring the case 11 will be described later.

### (Speaker Unit 16)

The speaker unit 16 is mainly configured including a yoke 20, a frame 22, a magnet 24, a top plate 26, a damper 28, a voice coil 30, and a diaphragm 32.

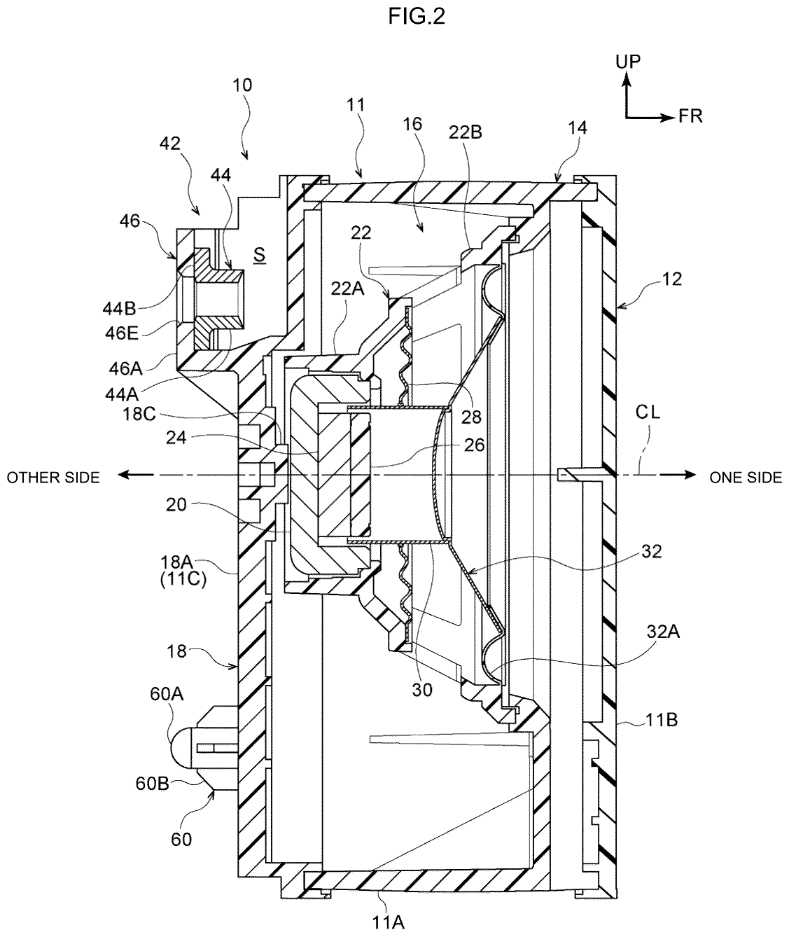

As illustrated in FIG. 2, the frame 22 is a substantially stepped cylindrical shape including a small diameter portion 22A and a tapered portion 22B, and as an example, is formed of a resin member. Further, the small diameter portion 22A of the frame 22 is disposed at the rear side, and the tapered portion 22B is disposed at the front side, and a center axis CL direction of the frame 22 is coincident with the front-rear direction. In the following explanation, there are cases in which the front side of the speaker unit 16 including the frame 22 is referred to as one side in the center axis CL direction, and the rear side of the speaker unit 16 is referred to as the other side in the center axis CL direction.

An end portion (axial direction other end portion) of the tapered portion 22B at the axial direction other side is connected to the small diameter portion 22A, and the tapered portion 22 is formed in a shape that is gradually increased in diameter toward the axial direction one side from this axial direction other end portion. Further, a diaphragm 32 is attached to an end portion (axial direction one end portion) of the tapered portion 22B at the axial direction one side.

The diameter of the diaphragm 32 gradually increases from the axial direction other end side toward the axial direction one end side, and the voice coil 30 is attached to a rear face of a center portion of the diaphragm 32. An annular groove portion 32A that is convex toward the axial direction other end side is formed at an outer peripheral end portion of the diaphragm 32. A portion of the diaphragm 32 that is further toward the outer peripheral side than the groove portion 32A is fixed to the axial direction one end portion of the frame 22, and the opening at the axial direction one end side of the frame 22 is closed by the diaphragm 32.

The axial direction one side portion of the frame 22 is connected to an axial direction one end portion of the case body 14, which is described later. Thus, an external space and an internal space of the case body 14 are partitioned by the diaphragm 32.

A yoke 20, a magnet 24, and a top plate 26 are provided inside the small diameter portion 22A of the frame 22. The yoke 20 is formed in the shape of a bottomed cylinder with a front side open, and is formed of a magnetic material. A front end portion of the yoke 20 abuts the frame 22, and a rear end portion of the yoke 20 abuts the rear cover 18. Thus, the yoke 20 is held in a state sandwiched between the frame 22 and the rear cover 18, which is described later.

The magnet 24 is formed in a substantially columnar shape with a smaller diameter than the yoke 20, and the magnet 24 of the present exemplary embodiment is formed of a neodymium magnet, as an example. The magnet 24 is disposed inside the yoke 20, and a rear face of the magnet 24 abuts a bottom portion of the yoke 20.

A top plate 26 is layered on the front side of the magnet 24. The top plate 26 is formed in a substantially columnar shape that is thinner than the magnet 24, and is formed of a magnetic material. A magnetic circuit is configured by the yoke 20, the magnet 24, and the top plate 26.

A gap is provided between the top plate 26 and the yoke 20, and the axial direction other end portion of the voice coil 30 is inserted into the gap. The voice coil 30 is formed by winding a conductor wire around a bobbin, not illustrated in the drawings, in a cylindrical shape, and the outside diameter of the voice coil 30 is slightly larger than the magnet 24 and the top plate 26. The axial direction one end portion of the voice coil 30 is fixed to a center portion of the diaphragm 32, and the diaphragm 32 is configured to deform in accordance with displacement of the voice coil 30.

A damper 28 is fixed to an outer peripheral face of the voice coil 30. The damper 28 is formed in a substantial disk shape with a center portion in the radial direction open, and is formed of a flexible member. The damper 28 is formed with a substantially wave-shaped cross-section, and an inner peripheral end portion of the damper 28 is fixed to a center portion in the axial direction of the voice coil 30, and an outer peripheral end portion of the damper 28 is fixed to the frame 22. Thus, the voice coil 30 is supported by the damper 28 so as to be capable of moving in the axial direction inside the frame 22.

Note that both end portions of the conductor wire configuring the voice coil 30 are connected to terminals, which are not illustrated in the drawings, and power is supplied to the voice coil 30 from a power source external to the vehicle electroacoustic transducer 10 via the terminals.

The speaker unit 16 is configured as described above, and power is supplied to the voice coil 30 and current flows through the voice coil 30, whereby the voice coil 30 moves reciprocally in the axial direction and vibrates the diaphragm 32. Further, sound is generated by the diaphragm 32 being vibrated.

### (Overall Configuration of Case 11)

Explanation follows regarding the case 11 in which the speaker unit 16 is housed.

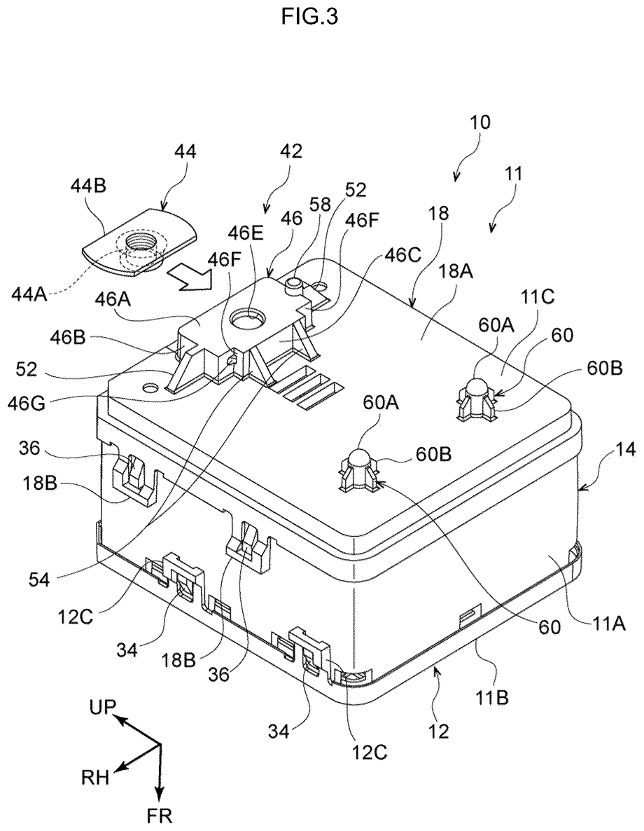

As illustrated in FIG. 3, the case 11 is formed in a box shape and houses the speaker unit 16, and further, includes a peripheral wall portion 11A that surrounds the periphery of the speaker unit 16, a front wall portion 11B that is arranged at one end side (front side) of the peripheral wall portion 11A, and a rear wall portion 11C that is arranged at the other end side (rear side) of the peripheral wall portion 11A.

As illustrated in FIG. 1, the case 11 is formed in a substantial box shape including a case body 14, a front cover 12, and a rear cover 18. The front cover 12 is attached to the front side of the case body 14, and the rear cover 18 is attached to a rear side of the case body 14. Thus, the peripheral wall portion 11A is configured by the case body 14, the front wall portion 11B is configured by the front cover 12, and the rear wall portion 11C is configured by the rear cover 18. The rear cover 18 is provided with an attachment face 18A that is disposed facing the attachment member 100 (see FIG. 4). Note that in the present exemplary embodiment, the case 11 has a three-part structure including the case body 14, the front cover 12, and the rear cover 18; however, there is no limitation to this, and an integral or two-part structure may be employed. Alternatively, a structure in which the case is divided into four or more portions may be employed.

### (Case Body 14)

The case body 14 is a substantially square tube shape with both sides open, and as an example, it is formed of a resin member such as a reinforcing fiber resin. The speaker unit 16 is held by the case body 14. Plural front side projecting portions 34 and plural rear side projecting portions 36 are formed on an outer peripheral face of the case body 14.

Two front side projecting portions 34 are formed at each of a right side face and a left side face at a front portion of the case body 14, and are configured to engage with front side claw portions 12C of the front cover 12, which are described later. Two rear side projecting portions 36 are formed further toward the rear than the front side projecting portions 34 at each of the right side face and the left side face of the case body 14, and are configured to engage with rear side claw portions 18B of the rear cover 18, which are described later.

A connector 38 is provided at a left side face of the case body 14. The connector 38 projects leftward from the case body 14, and terminals or the like, which are not illustrated in the drawings, at the external device side are connected to the connector 38.

A partition wall 14A that divides an internal space of the case body 14 into a front side and a rear side, with a plate thickness direction in a front-rear direction, is provided in the case body 14. Further, a circular through-hole 14B is formed in the partition wall 14A, and the through-hole 14B is configured to be closed by the diaphragm 32 of the speaker unit 16.

Further, a plug 40 made of resin is provided at the partition wall 14A. The plug 40 is attached to a communicating portion 14C formed at the partition wall 14A. The communicating portion 14C is formed of a through hole with a smaller diameter than the through-hole 14B, such that an external space at the front side of the partition wall 14A and an internal space at the rear side of the partition wall 14A are communicated with each other. A filter member, not illustrated in the drawings, that permits passage of air and blocks passage of liquid is provided at the communicating portion 14C, and the filter member is protected by the plug 40.

### (Front Cover 12)

A front cover 12 is disposed at the front side of the case body 14, and the front cover 12 is attached to the front side (the diaphragm 32 side) of the case body 14. The front cover 12 is in the shape of a substantially rectangular plate with its thickness direction along the front-rear direction, and as an example, it is formed of a resin member such as a reinforcing fiber resin.

Plural slits 12A are formed in the front cover 12, and sound generated by vibration of the diaphragm 32 of the speaker unit 16 passes through the slits 12A and is output to the outside of the vehicle electroacoustic transducer 10.

Note that plural slits 12A are formed in the left-right direction, and each slit 12A extends in the up-down direction. As an example, the slits 12A of the present exemplary embodiment have a labyrinth structure, and the structure is such that ingress of fluid entering from the front face (front face) to the rear face (rear face) of the front cover 12 is suppressed.

The slits 12A are formed in a portion of the case body 14 facing the through-hole 14B, and a portion of the front cover 12 facing a portion provided with the plug 40 (filter member) configures a blocking portion 12B at which the slits 12A are not formed.

Four front side claw portions 12C are provided at the front cover 12. Specifically, two front side claw portions 12C extend toward the rear side from a left side end portion of the front cover 12. Similarly, two front side claw portions, not illustrated in the drawings, extend toward the rear side from a right side end portion of the front cover 12. Locking holes into which the front side projecting portions 34 of the case body 14 enter are formed in the respective front side claw portions 12C, and the front cover 12 is locked by the front side projecting portions 34 entering the locking holes of the front side claw portions 12C.

### (Rear Cover 18)

A rear cover 18 is disposed at a rear side of the case body 14, and the rear cover 18 is attached to a rear side (an opposite side from the diaphragm 32) of the case body 14. The rear cover 18 has a substantially rectangular plate shape with a plate thickness direction in the front-rear direction, and as an example, it is formed of a resin member such as a reinforcing fiber resin. Further, a space at the opposite side of the case body 14 from the diaphragm 32 is sealed by the rear cover 18.

Four rear side claw portions 18B are provided at the rear cover 18. Specifically, two rear side claw portions 18B extend toward the front side from a left side end portion of the rear cover 18. Similarly, two rear side claw portions 18B extend toward the front side from a right side end portion of the front cover 12. Locking holes into which the rear side projecting portions 36 of the case body 14 enter are formed in the respective rear claw portions 18B, and the rear cover 18 is locked by the rear side projecting portions 36 entering the locking holes of the rear side claw portions 18B.

A support portion 18C is provided at a front face (rear face) of the rear cover 18. The support portion 18C protrudes toward the front side from the front face of the rear cover 18, and a leading end of the support portion 18C is formed in a substantially columnar shape. Further, as illustrated in FIG. 2, in a state in which the vehicle electroacoustic transducer 10 is assembled, the configuration is such that the rear face of the yoke 20 is pressed against the support portion 18C.

### (Attachment Portion 42)

As illustrated in FIG. 3, an attachment portion 42 that is attached to the attachment member 100 is provided at the attachment face 18A that is the rear face of the rear cover 18. In other words, the attachment portion 42 protrudes toward an opposite side from the front wall portion 11B side from the rear wall portion 11C, and is formed so as to be attachable to the attachment member 100. The attachment portion 42 is formed at the outside of the rear cover 18, and is configured including an attachment bracket 44 into which a bolt 102 (see FIG. 4), serving as a fastener, is screwed, and a bracket housing portion 46 that houses the attachment bracket 44.

The bracket housing portion 46 is integrally formed with the case body 14 so as to protrude rearward from the attachment face 18A, and is formed in a substantially rectangular shape when viewed from the rear side. Specifically, the bracket housing portion 46 is configured including a rear wall 46A, left and right side walls 46B, a lower wall 46C, and an upper wall 46D (see FIG. 4).

The rear wall 46A configures a rear portion of the bracket housing portion 46, with the front-rear direction being a plate thickness direction, and extends in the up-down direction and the left-right direction. An insertion hole 46E is formed in a center portion of the rear wall 46A. The insertion hole 46E is formed in a substantially circular shape, and a bolt 102 for fastening the case 11 to the attachment member 100 is sized so as to be able to be inserted therethrough (see FIG. 4).

Sidewalls 46B extend toward the front from left and right end portions of the rear wall 46A, and the side walls 46B each extend in the up-down direction and the front-rear direction with the left-right direction as their plate thickness directions. Further, each side wall 46B is provided with a reinforcing rib 52. The reinforcing ribs 52 are formed in a substantially trapezoidal shape when viewed from the plate thickness direction, with the up-down direction as the plate thickness direction. The respective left and right side walls 46B and the attachment face 18A are coupled to each other by the reinforcing ribs 52.

Here, a positioning pin 58 is formed at the left side wall 46B. The pin 58 is integrally formed with the bracket housing portion 46, and projects further toward the rear side than the rear wall 46A. The pin 58 is formed in a substantially columnar shape, and is inserted into a positioning hole, which is not illustrated in the drawings, formed in the attachment member 100.

A lower wall 46C extends toward the front from a lower end portion of the rear wall 46A, and the lower wall 46C extends in the front-rear direction and the left-right direction with the up-down direction as its plate thickness direction. A left and right pair of reinforcing ribs 54 are provided at the lower wall 46C. The reinforcing ribs 54 are formed in a substantially triangular shape when viewed from the plate thickness direction, with the left-right direction as the plate thickness direction. The lower wall 46C and the attachment face 18A are coupled to each other by the reinforcing ribs 54.

Note that corner portions 46F having an internal corner shape are provided between the left and right side walls 46B and the lower wall 46C. A cutout portion 46G for draining water is formed at each of the left and right pair of corner portions 46F. The cutout portion 46G is formed across the side wall 46B and the lower wall 46C, and the configuration is such that water can be drained from two directions, the up-down direction and the left-right direction. Note that in FIG. 3, only the cutout portion 46G formed at the left corner portion 46F is visible; however, a cutout portion 46G is similarly formed in the right corner portion 46F.

Thus, in the present exemplary embodiment, as an example, the cutout portions 46G are formed at plural positions of the bracket housing portion 46. Further, each cutout portion 46G is formed by circular penetration of a portion of the corner portion 46F. The cutout portions 46G are formed at an opposite side from the insertion hole 46H, described later, in the bracket housing portion 46 in the up-down direction.

As illustrated in FIG. 4, the upper wall 46D extends toward the front from the upper end of the rear wall 46A, and extends in the front-rear direction and the left-right direction with the up-down direction as a plate thickness direction. An insertion hole 46H into which the attachment bracket 44 can be inserted is formed in the upper wall 46D.

The insertion hole 46H is formed in a substantial T-shape including a left and right extending portion extending left and right as viewed from above, and a front-rear extending portion extending toward the front side from a center portion of the left and right extending portion. The front-rear extending portion of the insertion hole 46H extends further toward the front than the attachment face 18A of the rear cover 18. Thus, the attachment portion 42 is formed in a shape that enables the attachment bracket 44 to be attached and detached, with a gap S provided between the bracket housing portion 46 and the attachment bracket 44 in a state in which the attachment bracket 44 is housed in the bracket housing portion 46. The gap S is provided between the bracket housing portion 46 and the attachment bracket 44 at the front-rear extending portion and the left-right extending portions of the insertion hole 46H.

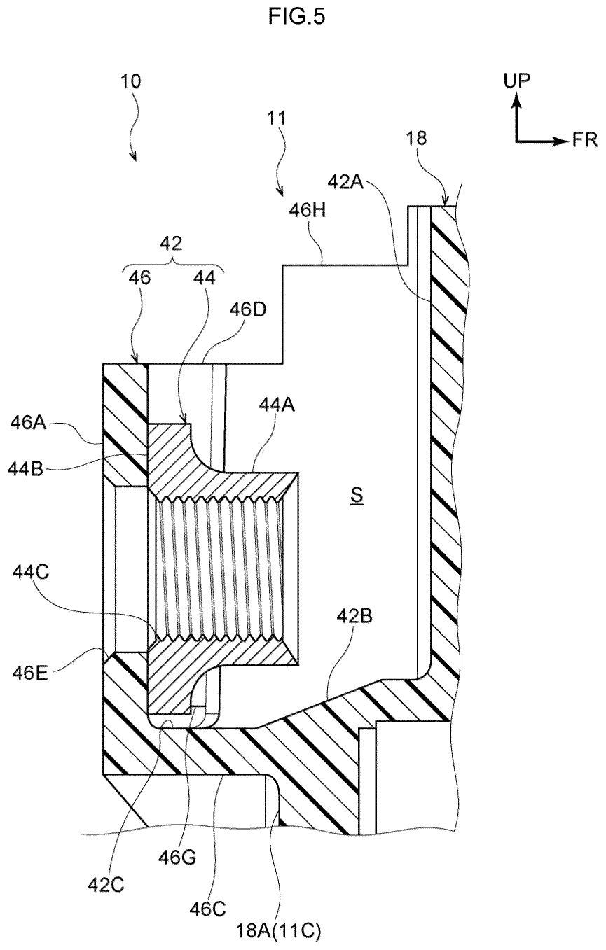

As illustrated in FIG. 5, the inside wall of the bracket housing portion 46 in the attachment portion 42 is configured including an up-down wall portion 42A, an inclined portion 42B, and a front-rear wall portion 42C, as viewed from the left-right direction. The up-down wall portion 42A configures an inside wall at the front side of the insertion hole 46H, and extends in the up-down direction. The up-down wall portion 42A extends further upward than the rear wall 46A that it faces in the front-rear direction.

The inclined portion 42B and the front-rear wall portions 42C configure a bottom wall of the insertion hole 46H, and extend in the front-rear direction. Here, the front-rear wall portion 42C extends toward the front side from a lower end of the rear wall 46A to a center portion in the front-rear direction of the insertion hole 46H. The front-rear wall portion 42C and the up-down wall portion 42A are linked by the inclined portion 42B.

The inclined portion 42B tilts downward from the up-down wall portion 42A toward the front-rear wall portion 42C. Respective left and right end portions of the front-rear wall portion 42C are connected to edge portions forming the cutout portions 46G. In other words, the inclined portion 42B formed on the inside wall of the bracket housing portion 46 is inclined toward the cutout portions 46G.

As illustrated in FIGS. 3 and 4, the attachment bracket 44 is formed separately from the case 11. The attachment bracket 44 is a so-called T-type nut including a tube portion 44A and a flange portion 44B, and in the present exemplary embodiment, the attachment bracket 44 is formed of a steel material, as an example.

The flange portion 44B extends from the tube portion 44A in the radial direction of the tube portion 44 A with the front-rear direction serving as a plate thickness direction. The flange portion 44B is formed in a laterally elongate shape with a length in one direction that is longer than a length in the other direction, out of two directions orthogonal to the plate thickness direction. In the present exemplary embodiment, the flange portion 44B extends in the left-right direction and the up-down direction, and is formed in a laterally elongate shape such that the length in the left-right direction is longer than the length in the up-down direction.

A threaded hole 44C that is communicated with the insertion hole 46E in a state in which the attachment bracket 44 is housed in the bracket housing portion 46 and to which the bolt 102 is screwed is formed in the tube-shaped portion 44A of the attachment bracket 44. Specifically, as illustrated in FIG. 5, in a state in which the attachment bracket 44 is inserted into the insertion hole 46H of the bracket housing portion 46, the screw hole 44C formed in the attachment bracket 44 is communicated with the insertion hole 46E of the bracket housing portion 46.

The attachment portion 42 is configured as described above, and by inserting the bolt 102 through the insertion hole 46E of the bracket housing portion 46, and screwing the bolt 102 into the threaded hole 44C of the attachment bracket 44, the attachment portion 42 of the case 11 is fixed to the attachment member 100. At such time, the attachment member 100 and the rear wall 46A of the bracket housing portion 46 assume a state that is sandwiched between the attachment bracket 44 and the bolt 102.

### (Boss Portion 60)

As illustrated in FIG. 3, two boss portions 60 protrude from the attachment face 18A of the case 11. Of the two boss portions 60, one boss portion 60 is provided in the vicinity of the lower right corner portion of the attachment face 18A, and the other boss portion 60 is provided in the vicinity of the lower left corner portion of the attachment face 18A. In other words, the attachment portion 42 is formed at one end portion of the attachment face 18A, and the boss portions 60 are formed at the other end portion of the attachment face 18A.

Each boss portion 60 is configured including a main body portion 60A and ribs 60B. The main body portion 60A is formed in a substantially columnar shape, and a leading end of the main body portion 60A is formed in a substantially spherical shape. Four ribs 60B are formed at equal intervals around the main body portion 60A. The respective ribs 60B connect the main body portion 60A to the attachment face 18A.

As illustrated in FIG. 2, the leading end of the main body portion 60A of the boss portion 60 is positioned further rearward than the rear wall 46A of the bracket housing portion 46 configuring the attachment portion 42. Namely, the height of the boss portion 60 with respect to the attachment face 18A is higher than the height of the attachment portion 42 with respect to the attachment face 18A. Thus, when the case 11 is attached to the planar attachment member 100, the main body 60A of the boss portion 60 is pressed against the attachment member 100.

### (Mechanism)

Explanation follows regarding the mechanism of the present exemplary embodiment.

In the vehicle electroacoustic transducer 10 according to the present exemplary embodiment, the speaker unit 16 is housed in the case 11. As illustrated in FIG. 3, the case 11 is configured including a peripheral wall portion 11A, a front wall portion 11B, and a rear wall portion 11C. Since the attachment portion 42 is formed at the case 11, the case 11 can be attached to the attachment member 100 via the attachment portion 42.

Note that the attachment portion 42 protrudes from the rear wall portion 11C of the case 11 toward an opposite side (rear side) from the front wall portion 11B side. This enables the case to be attached in a smaller space than in a configuration in which the attachment portion is provided around the peripheral wall portion 11A. Namely, in configurations in which flanges are extended from the peripheral wall portion 11A of the case 11 in the left-right direction or the up-down direction, there is a possibility that the flanges will interfere with peripheral components. In contrast thereto, in the vehicle electroacoustic transducer 10 of the present exemplary embodiment, the attachment portion 42 is provided at a position overlapping with the case 11 in the front-rear direction, and therefore, even in cases in which other components are disposed around the peripheral wall portion 11A, the case 11 can be attached to the attachment member 100.

In the present exemplary embodiment, an “outsert” structure is employed in which the attachment bracket 44 is inserted into the insertion hole 46H of the bracket housing portion 46. Thus, compared to the structure of an insert in which the attachment bracket 44 would be integrally molded at the bracket housing portion 46 (the case 11), it is possible to suppress deterioration of the interface between the case 11 and the attachment bracket 44 under the influence of water or the like.

As illustrated in FIG. 4, in the present exemplary embodiment, when the case 11 is attached to the attachment member 100 by the bolt 102 serving as a fastener, the bolt 102 and the attachment bracket 44 are screwed together in a state in which the bolt 102 is inserted into the insertion hole 46E formed in the bracket housing portion 46. Thus, since the rear wall 46A of the bracket housing portion 46 is sandwiched between the attachment bracket 44 and the bolt 102, the case 11 can be more firmly attached to the attachment member 100. Further, as a result of attaching the case 11 to the attachment member 100 via the bracket housing portion 46, the load can be distributed by increasing the area in contact with the attachment member 100.

Further, in the present exemplary embodiment, as a result of configuring the flange portion 44B of the attachment bracket 44 in a laterally elongate shape, even in cases in which an impact is input to the attachment portion 42 from the attachment member 100 side, the impact can be dispersed by the flange portion 44B. In cases in which the flange portion 44B has a circular shape with a large diameter, the bracket housing portion 46 itself needs to be made larger in size; however, as a result of configuring the flange portion 44B in a laterally elongate shape, the length in the up-down direction can be reduced, and there is no need to make the bracket housing portion 46 larger in size. Further, as a result of configuring the flange portion 44B in a laterally elongate shape, the flange portion 44B contacts the bracket housing portion, thereby enabling rotation of the attachment bracket 44 to be suppressed.

In the present exemplary embodiment, the clearance S is provided between the bracket housing portion 46 and the attachment bracket 44, such that the attachment bracket 44 can be easily attached and detached. This enables the operational efficiency of inserting the attachment bracket 44 into the bracket housing portion 46 to be improved. The attachment bracket 44 can be easily modified in accordance with the specifications or the like of the attachment member 100.

Further, as illustrated in FIG. 3, in the present exemplary embodiment, since the cutout portion 46G for water drainage is formed in the bracket housing portion 46, even in cases in which water has entered the bracket housing portion 46, water can be drained from the cutout portion 46G, and the occurrence of residual water in the bracket housing portion 46 can be suppressed.

In particular, in the present exemplary embodiment, the notched portions 46G are formed at the left and right corner portions 46F of the bracket housing portion 46, thereby enabling the occurrence of residual water at the corner portions 46F to be suppressed. Further, compared to a configuration in which the cutout portion 46G is formed only at one place, the water drainage performance can be further improved.

In the present exemplary embodiment, an insertion hole 46H is formed at an upper end portion of the bracket housing portion 46, and the cutout portion 46G is formed at a lower end portion of the bracket housing portion 46, which is at an opposite side from the insertion hole 46H. This enables water to be drained from the cutout portion 46G, even in cases in which water has entered via the insertion hole 46H to the innermost part of the bracket housing portion 46.

As illustrated in FIG. 5, in the present exemplary embodiment, an inclined portion 42B is formed at an inside wall of the insertion hole 46H, and water that has entered the bracket housing portion 46 is guided to the cutout portion 46G by the inclined portion 42B. This enables water in the bracket housing portion 46 to be efficiently drained. Thus, the vehicle electroacoustic transducer 10 of the present exemplary embodiment enables deterioration of the case 11 due to residual water to be suppressed.

As illustrated in FIG. 3, in the above exemplary embodiment, the boss portion 60 protrudes from the attachment face 18A of the case 11, and the boss portions 60 contact the attachment member 100. Thus, in a state in which the case 11 is attached to the attachment member 100, the case 11 is supported at plural positions consisting of the attachment portion 42 and the boss portions 60, thereby enabling suppression of sympathetic vibration by the case 11.

In particular, in the present exemplary embodiment, the attachment portion 42 is provided at an upper portion of the attachment face 18A, and two boss portions 60 are provided at a lower portion of the attachment face 18A. Thus, the case 11 contacts the attachment member 100 at three points, thereby effectively suppressing sympathetic vibration by the case 11. Further, excluding the attachment portion 42 and the boss portion 60, a gap is provided between the case 11 and the attachment member 100, and therefore, even in environments in which the temperature at the attachment member 100 side becomes high, the speaker unit 16 is not affected by heat.

In the present exemplary embodiment, since the boss portions 60 are formed to project further toward the rear than the attachment portion 42, when the attachment portion 42 is attached to the attachment member 100, the boss portions 60 can be reliably abutted against the attachment member 100.

When the boss portions 60 are pressed against the attachment member 100, abnormal noise due to vibration of the case 11 can be suppressed. Namely, in cases in which the height of the attachment portion 42 with respect to the attachment face 18A and the height of the boss portions 60 are formed at the same height, there is a possibility that a slight gap will be created between the boss portions 60 and the attachment member 100 owing to design error, assembly error, or the like. In such cases, abnormal noise might be generated by contact between the boss portion 60 and the attachment member 100 as a result of vibration of the diaphragm 32 due to actuation of the vehicle electroacoustic transducer 10.

In contrast thereto, by adopting a configuration in which the boss portions 60 are pressed against the attachment member 100 as in the present exemplary embodiment, no slight gap is created between the boss portions 60 and the attachment member 100, and generation of abnormal noise can be suppressed.

In the present exemplary embodiment, because the leading end of the attachment portion 42—namely, the rear wall 46A of the bracket housing portion 46—is formed in a plane, the attachment portion 42 and the attachment member 100 can be attached in face-to-face contact with each other, and the attachment state can be stabilized.

In contrast thereto, the leading ends of the boss portions 60 are spherical in shape, and therefore, the case 11 can be supported by the boss portions 60 in a state in which the boss portions 60 and the attachment member 100 are in point contact with each other.

In the present exemplary embodiment, a front cover 12 is attached to a diaphragm 32 side (front side) of the case body 14, and a rear cover 18 is attached to an opposite side (rear side) of the case body 14 from the diaphragm 32. In this manner, by configuring the front cover 12 and the rear cover 18 separately from the case body 14 that holds the speaker unit 16, when the design of the speaker unit 16 is changed, only the case body 14 needs to be changed in design. Namely, if the internal structure of the case body 14 is to be changed in accordance with a design change of the speaker unit 16, the speaker unit 16 can be held. As long as the external structure of the case body 14 is not changed, the front cover 12 and the rear cover 18 can be attached in the same manner as before the design change.

In the present exemplary embodiment, simply by changing the front cover 12 or the rear cover 18, it is possible to address changes in the application and usage environment of the vehicle electroacoustic transducer 10. In particular, since, in the present exemplary embodiment, the attachment portion 42 is formed at the rear cover 18, the vehicle electroacoustic transducer 10 can be attached simply by changing the rear cover 18 in accordance with the specifications of the attachment member 100. In environments in which plural fastening portions are required, for example, if the rear cover 18 is changed and a rear cover with plural attachment portions 42 formed thereon is prepared, the vehicle electroacoustic transducer 10 can be attached without changing the design of the case body 14 and the front cover 12.

In the present exemplary embodiment, a space at the rear side of the case body 14 is sealed by the rear cover 18, and the attachment portion 42 is formed at the outside of the rear cover 18. Thus, compared to a configuration in which the attachment portion 42 is communicated with the internal space of the case body 14, it is possible to suppress the entry of foreign matter into the inside of the case body 14 from the rear cover 18 side.

As illustrated in FIG. 1, in the present exemplary embodiment, the external space and the internal space of the case body 14 are communicated with each other through the communicating portion 14C. Thus, even in cases in which temperature, atmospheric pressure, or the like have changed between the external space and the internal space of the case body 14, air enters and exits between the external space and the internal space through the communicating portion 14C, which enables deformation of the diaphragm 32 to be suppressed. Further, since liquid is prevented from passing through the communicating portion 14C by the filter member, ingress of liquid into the internal space of the case body 14 can be suppressed.

In the above exemplary embodiment, sound output from the speaker unit 16 is transmitted to the outside through the slits 12A formed in the front cover 12. Since the portion facing the plug 40 that protects the filter member is the blocking portion 12B, even in cases in which foreign matter, water droplets, or the like have been sprayed onto the front cover 12, the filter member can be protected satisfactorily.

### SUPPLEMENTARY EXPLANATION

While explanation has been given above regarding the vehicle electroacoustic transducer 10 according to an exemplary embodiment, needless to say, various embodiments may be practiced within a range that does not depart from the spirit of the present disclosure. For example, in the above exemplary embodiment, as illustrated in FIG. 3, the attachment portion 42 is provided at the upper end portion of the attachment face 18A; however, there is no limitation to this, and the attachment portion 42 may be provided at another location. Namely, the attachment portion 42 may be provided at a center portion of the attachment face 18A. Alternatively, the configuration may be such that plural attachment portions 42 are provided at the attachment face 18A.

In the above exemplary embodiment, two boss portions 60 are provided at the attachment face 18A; however, the present disclosure is not limited thereto. For example, the configuration may be such that boss portions 60 are not provided.

As illustrated in FIG. 1, in the above exemplary embodiment, a speaker unit 16 that generates sound by reciprocal movement of the voice coil 30 is employed; however, there is no limitation to this. For example, a speaker unit that generates sound using another structure may be employed.

In the above exemplary embodiment, an “outsert” structure, in which the attachment bracket 44 is inserted into the insertion hole 46H of the bracket housing portion 46, is employed; however, the present disclosure is not limited thereto.

The disclosure of Japanese Patent Application No. 2022-053453 is hereby incorporated by reference in its entirety.

All documents, patent applications, and technical standards described herein are hereby incorporated by reference to the same extent as if each document, patent application, and technical standard were specifically and individually described as being incorporated by reference.

1. An electroacoustic transducer for a vehicle, the electroacoustic transducer comprising:
a speaker unit that generates sound; and
a case that is formed in a box-shape and accommodates the speaker unit, and that includes a peripheral wall portion that surrounds a periphery of the speaker unit, a front wall portion disposed at one end side of the peripheral wall portion, and a rear wall portion disposed at another end side of the peripheral wall portion,
wherein an attachment portion that protrudes from the rear wall portion toward an opposite side from a side of the front wall portion, and that is attachable to an attachment member outside a vehicle cabin, is formed at the case.

2. The electroacoustic transducer for a vehicle of claim 1, wherein the attachment portion includes:
an attachment bracket that is separate from the case, and
a bracket housing portion formed integrally with the case and provided with an insertion hole into which the attachment bracket is insertable.

3. The electroacoustic transducer for a vehicle of claim 2, wherein:
a through-hole penetrable by a fastener is formed at the bracket housing portion, and
a screw hole is formed at the attachment bracket, the screw hole being communicated with the through-hole in a state in which the attachment bracket is housed in the bracket housing portion, and into which the fastener is screwed.

4. The electroacoustic transducer for a vehicle of claim 3, wherein:
the attachment bracket includes a cylindrical portion at which the screw hole is formed, and a flange portion extending from the cylindrical portion in a radial direction of the cylindrical portion, and
the flange portion is formed in a laterally elongate shape such that a length in one direction is longer than a length in another direction among two directions orthogonal to a plate thickness direction.

5. The electroacoustic transducer for a vehicle of claim 2, wherein the attachment portion is formed such that a gap is provided between the bracket housing portion and the attachment bracket, and the attachment bracket is detachable in a state in which the attachment bracket is housed in the bracket housing portion.
